(19) United States
(12) Patent Application Publication
(10) Pub. No.: US 2019/0247978 A1
(43) Pub. Date: Aug. 15, 2019

(54) MANUFACTURING METHOD FOR HIGH PRESSURE TANK

(71) Applicant: TOYOTA JIDOSHA KABUSHIKI KAISHA, Toyota-shi (JP)

(72) Inventor: Yoshihiro NAKATA, Toyota-shi (JP)

(21) Appl. No.: 16/269,876

(22) Filed: Feb. 7, 2019

(30) Foreign Application Priority Data
Feb. 15, 2018 (JP) 2018-025467

(51) Int. Cl. B24C 1/10; F17C 1/02

(52) U.S. Cl. CPC B24C 1/10; F17C 1/02; F17C 2201/0109; F17C 2203/0604; F17C 2203/0646; F17C 2209/2154; F17C 2203/012; F17C 2203/0619; F17C 2203/0639; F17C 2209/232; F17C 2203/067

(57) ABSTRACT

A manufacturing method for a high pressure tank includes preparing a liner including a cylindrical body portion and a pair of side end portions, forming a reinforcing layer by winding fiber-reinforced resin around an outer peripheral surface of the liner, carrying out shot peening by shooting a shot material towards an inner periphery region of a boundary between the body portion and each of the side end portions, and carrying out autofrettage after the reinforcing layer is formed and the shot peening is carried out. The autofrettage is carried out by applying internal pressure to the liner such that the liner is plastically deformed and then eliminating the internal pressure such that compression stress is applied to the liner.

### INCORPORATION BY REFERENCE

The disclosure of Japanese Patent Application No. 2018-025467 filed on Feb. 15, 2018 including the specification, drawings and abstract is incorporated herein by reference in its entirety.

### BACKGROUND

### 1. Technical Field

The disclosure relates to a manufacturing method for a high pressure tank that includes a metal liner that stores gas, and a reinforcing layer that is made from fiber-reinforced resin and formed on an outer peripheral surface of the liner.

### 2. Description of Related Art

Gas that is supplied to a fuel cell, such as hydrogen gas, is stored in a high pressure tank in a pressurized state. Such a high pressure tank includes a metal liner that stores gas, and a reinforcing layer that is made from fiber-reinforced resin and formed on an outer peripheral surface of the liner. For example, Japanese Unexamined Patent Application Publication No. 2016-89891 (JP 2016-89891 A) discloses a manufacturing method for this kind of a high pressure tank in which a technique is used to carry out autofrettage by which internal pressure is applied to a liner so that the liner is plastically deformed.

### SUMMARY

In the liner, there is a boundary (a shoulder) between a body portion and each dome-shaped side end portion that is formed continuously with each side of the body portion, and the boundary is where an outer diameter and an inner diameter of the liner start to reduce (a diameter-reduced portion) towards each end portion of the liner from the body portion of the liner. According to the knowledge of the inventors, when internal pressure is applied to the liner having such a shape, stress tends to be intense in the boundary.

Therefore, as described in JP 2016-89891 A, when internal pressure is applied to the liner during the autofrettage, the boundary can receive more tensile stress than expected compared to stress generated on the rest of the parts of the body portion of the liner. As a result, due to the unexpectedly large tensile stress acting on the boundary during the autofrettage, even when compression stress is applied to the liner by the autofrettage, fatigue strength of each of the boundaries can be smaller than fatigue strength of the rest of the parts of the liner.

The disclosure provides a manufacturing method for a high pressure tank. The manufacturing method is able to restrain a decrease in fatigue strength of a boundary between a body portion and each side end portion of a metal liner, assuming that autofrettage is carried out on the liner.

A first aspect of the disclosure is a manufacturing method for a high pressure tank. The method includes preparing a metal liner that stores gas and includes a cylindrical body portion and a pair of dome-shaped side end portions, the side end portions being formed continuously with both sides of the body portion, respectively, forming a reinforcing layer by winding fiber-reinforced resin around an outer peripheral surface of the liner, carrying out shot peening by shooting a shot material towards an inner periphery region of a boundary between the body portion and each of the side end portions out of an inner peripheral surface of the liner, and carrying out autofrettage after the reinforcing layer is formed and the shot peening is carried out. The autofrettage is carried out by applying internal pressure to the liner such that the liner is plastically deformed and then eliminating the internal pressure. Thus, compression stress is applied to the liner.

According to the first aspect of the disclosure, since the shot peening is carried out at least on the inner periphery region of each of the boundaries out of the inner peripheral surface of the liner, it is possible to apply compressive residual stress to a surface layer including the inner periphery region of each of the boundaries. Thus, even when the autofrettage is carried out thereafter where internal pressure is applied to the liner such that the liner is plastically deformed, actual tensile stress generated on each of the boundaries is reduced due to the compressive residual stress applied on each of the boundaries. As a result, when internal pressure is applied to the liner during the autofrettage, a decrease in fatigue strength of each of the boundaries of the liner due to excessive tensile stress is restrained.

When the liner is manufactured by, for example, spinning, wrinkles and the like are formed in each of the boundaries where a diameter starts to reduce from the body portion towards each of the side end portions, and projections and recesses are formed easily in the inner periphery region of each of the boundaries. However, in the first aspect of the disclosure, the inner periphery region of each of the boundaries is smoothed by the shot peening. Therefore, the autofrettage does not result in a decrease in strength of each of the boundaries.

Further, in a step of carrying out the shot peening, a range where the shot material is shot is not particularly limited as long as the range includes the inner periphery region of each of the boundaries between the body portion and each of the side portions. The shot material may be shot towards the entire inner peripheral surface of the liner. Further, when the shot peening is carried out, the shot material may be shot towards a range from the inner periphery region of each of the boundaries through an inner peripheral surface of each of the side end portions.

When the internal pressure is applied to the liner during the autofrettage, larger tensile stress acts on each of the boundaries and each of the side end portions compared to tensile stress acting on the cylindrical body portion because of the shapes of the boundaries and the side end portions. However, with this aspect, the shot peening is carried out on the inner peripheral surfaces of the boundaries and the side end portions, thereby reducing tensile stress.

Further, since the shot peening is carried out partially, time required for shooting the shot material is shorter compared to a case where the shot peening is carried out on the entire surface. As a result, productivity of the high pressure tank is improved. Further, when the liner is manufactured by spinning, projections and recesses are easily formed due to wrinkles and the like not only on the inner periphery region of each of the boundaries, but also on the inner peripheral surface of each of the side end portions. However, with this aspect, the inner peripheral surface is smoothed by the shot peening.

The aforementioned fiber-reinforced resin may be made from reinforcing fiber impregnated with thermoplastic resin or thermosetting resin, and the reinforcing layer may be formed before or after the shot peening is carried out as long as the reinforcing layer is formed before carrying out the autofrettage. Further, the fiber-reinforced resin may be made from reinforcing fiber impregnated with thermosetting resin, and the reinforcing layer may be formed by winding the fiber-reinforced resin made from the reinforcing fiber impregnated with the uncured thermosetting resin around the outer peripheral surface of the liner, and then thermally curing the thermosetting resin. The reinforcing layer may be formed before the shot peening is carried out.

In this aspect, the reinforcing layer is formed before the shot peening is carried out. Thus, heat generated when the thermosetting resin is thermally cured does not reduce or eliminate compressive residual stress applied on the boundaries by the shot peening. Accordingly, compressive residual stress applied by the shot peening on the surface layer of each of the boundaries is used efficiently so as to carry out the autofrettage. Therefore, it is possible to restrain a decrease in fatigue strength of each of the boundaries between the body portion and each of the side portions of the liner.

In the first aspect of the disclosure, during the autofrettage, inert gas under pressure of 70 MPa to 180 MPa may be filled inside the liner such that internal pressure is applied to the liner.

In the first aspect of the disclosure, the shot peening may apply compressive residual stress of 10 MPa to 400 MPa to a surface layer of the liner.

A second aspect of the disclosure is a manufacturing method for a high pressure tank. The method includes preparing a metal liner that stores gas and includes a cylindrical body portion and a pair of dome-shaped side end portions, the side end portions being formed continuously with both sides of the body portion, respectively, forming a reinforcing layer by winding fiber-reinforced resin around an outer peripheral surface of the liner, carrying out autofrettage by applying internal pressure to the liner such that the liner is plastically deformed and then eliminating the internal pressure such that compression stress is applied to the liner, carrying out shot peening by shooting a shot material towards an inner periphery region of a boundary between the body portion and each of the side end portions out of an inner peripheral surface of the liner after the reinforcing layer is formed and the autofrettage is carried out.

In the second aspect of the disclosure, the shot material may be shot towards a range from the inner periphery region of each of the boundaries through an inner peripheral surface of each of the side end portions when the shot peening is carried out.

In the second aspect of the disclosure, the fiber-reinforced resin is made from reinforcing fiber impregnated with thermosetting resin, and the reinforcing layer may be formed by winding the fiber-reinforced resin made from the reinforcing fiber impregnated with the uncured thermosetting resin around the outer peripheral surface of the liner, and then thermally curing the thermosetting resin.

In the second aspect of the disclosure, during the autofrettage, inert gas under pressure of 70 MPa to 180 MPa may be filled inside the liner such that internal pressure is applied to the liner.

In the second aspect of the disclosure, the shot peening may apply compressive residual stress of 10 MPa to 400 MPa to a surface layer of the liner.

According to the disclosure, assuming that autofrettage is carried out on the metal liner, it is possible to restrain a decrease in fatigue strength of each of the boundaries between the body portion and each of the side end portions of the liner.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic sectional view of a high pressure tank according to an embodiment;

FIG. 2 is a schematic enlarged sectional view of the vicinity of a boundary in the high pressure tank shown in FIG. 1;

FIG. 3 is a flowchart describing steps of a manufacturing method for the high pressure tank according to the embodiment;

FIG. 4A is a schematic view describing a preparation step shown in FIG. 3;

FIG. 4B is a schematic view describing a reinforcing layer forming step shown in FIG. 3;

FIG. 4C is a schematic view describing a shot peening step shown in FIG. 3;

FIG. 4D is a schematic view describing an autofrettage pressure application step included in an autofrettage step shown in FIG. 3;

FIG. 5 shows a stress-strain curve pertaining to a body portion and each of the boundaries of a liner from the beginning of autofrettage pressure application to completion of autofrettage pressure elimination; and

FIG. 6 is a flowchart describing steps of a manufacturing method for a high pressure tank according to another embodiment.

### DETAILED DESCRIPTION OF EMBODIMENTS

Hereinafter, manufacturing methods for a high pressure tank according to an embodiment and another embodiment of the disclosure are described with reference to the drawings.

### Embodiment

1. High Pressure Tank 1

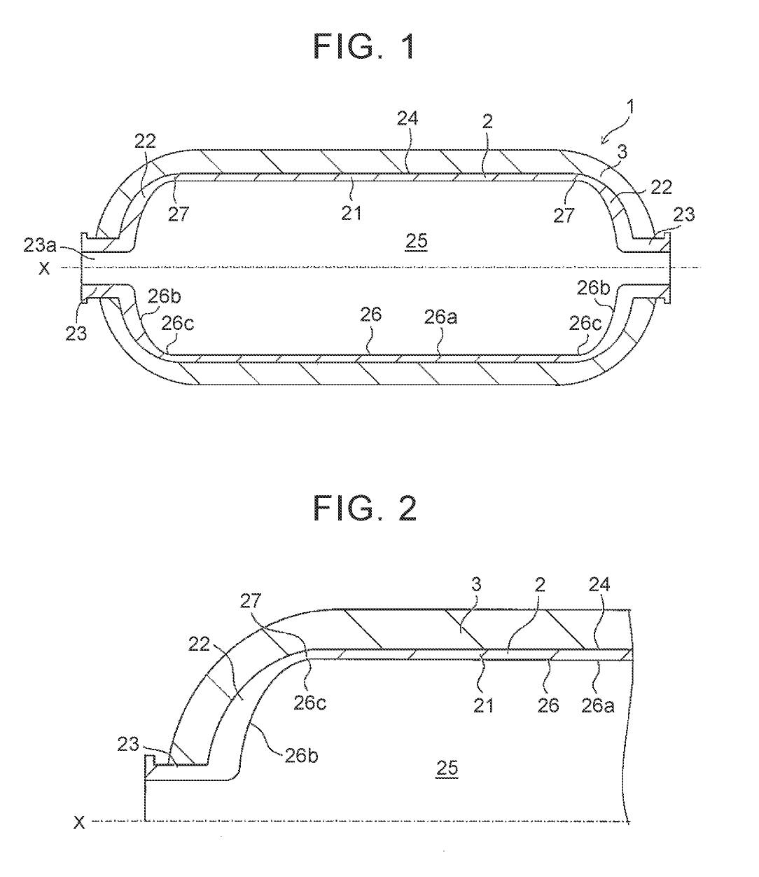

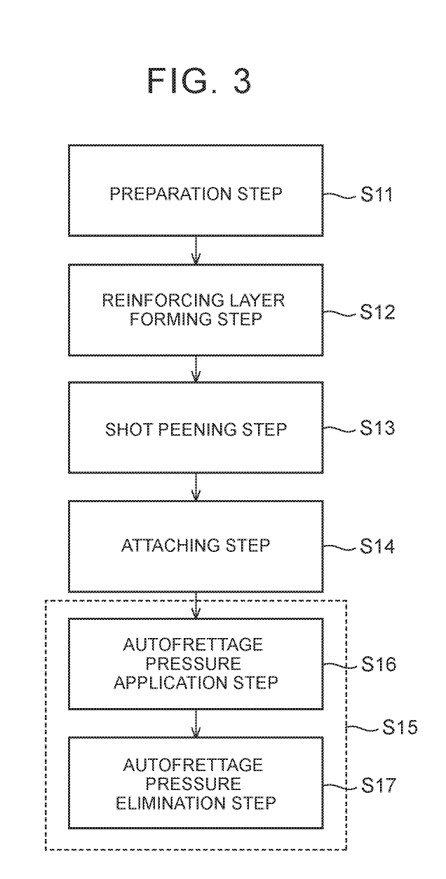

First of all, with reference to FIG. 1 and FIG. 2, a high pressure tank 1 according to an embodiment is described. FIG. 1 is a schematic sectional view of the high pressure tank 1 according to the embodiment. FIG. 2 is a schematic enlarged sectional view of the vicinity of a boundary 27 of the high pressure tank 1. FIG. 1 and FIG. 2 are sectional views taken along an axis X of the high pressure tank 1.

The high pressure tank 1 according to the embodiment is used for a natural gas vehicle, a fuel cell vehicle, and so on. As shown in FIG. 1, the high pressure tank 1 includes a liner 2 and a reinforcing layer 3 that is made from fiber-reinforced resin and formed on an outer peripheral surface 24 of the liner 2. The liner 2 is a portion that is also referred to as an inner shell or an inner container of the high pressure tank 1, and houses gas inside in a high-pressure state. Gas that is housed in the liner 2 is, for example, hydrocarbon-based fuel gas or hydrogen gas.

In the embodiment, the liner 2 is a metal liner. Metal used to form the liner 2 is, for example, an aluminum alloy or steel. The aluminum alloy may be, for example, an Al—Mg—Si-based alloy. The Al—Mg—Si-based alloy may be, for example, A6061-T6 specified by the JIS standard. Steel may be, for example, stainless steel.

The liner 2 includes a body portion 21 and a pair of side end portions 22. The body portion 21 and the side end portions 22 form a housing space 25 inside the liner 2 for housing (being filled with) gas.

In the embodiment, the body portion 21 has a cylindrical shape and extends by a predetermined length along the axis X of the high pressure tank 1. The side end portions 22 have a dome shape, and are formed continuously with both sides of the body portion 21 so as to cover openings on both sides of the body portion 21, respectively. To be specific, an outer diameter and an inner diameter of each of the side end portions 22 are reduced in a direction away from the body portion 21 along the axis X, and a mouthpiece 23 having an opening 23a is formed in an end portion of each of the side end portions 22.

In the embodiment, the liner 2 is formed by later-described spinning. Therefore, as shown in FIG. 2, a thickness of the liner 2 increases from the boundary 27 between the body portion 21 and each of the side end portions 22 towards an end portion of each of the side end portions 22 (specifically, towards the mouthpiece 23).

The reinforcing layer 3 configures outer walls of the body portion 21 and each of the side end portions 22. The reinforcing layer 3 is a layer formed by winding fiber-reinforced resin. Specifically, the reinforcing layer 3 is formed by winding filament around the liner 2 in hoop and helical winding patterns so as to cover the outer peripheral surface 24 of the liner 2. The filament is made of reinforcing fiber impregnated with polymeric resin.

The reinforcing layer 3 is fiber-reinforced resin made of the foregoing reinforcing fiber impregnated with thermoplastic resin or thermosetting resin as the polymeric resin. The reinforcing fiber includes, for example, glass fiber, carbon fiber, and aramid fiber. The thermoplastic resin includes, for example, polyester resin, polypropylene resin, and nylon resin. The thermosetting resin includes, for example, epoxy resin and vinyl ester resin.

2. Manufacturing Method for High Pressure Tank 1

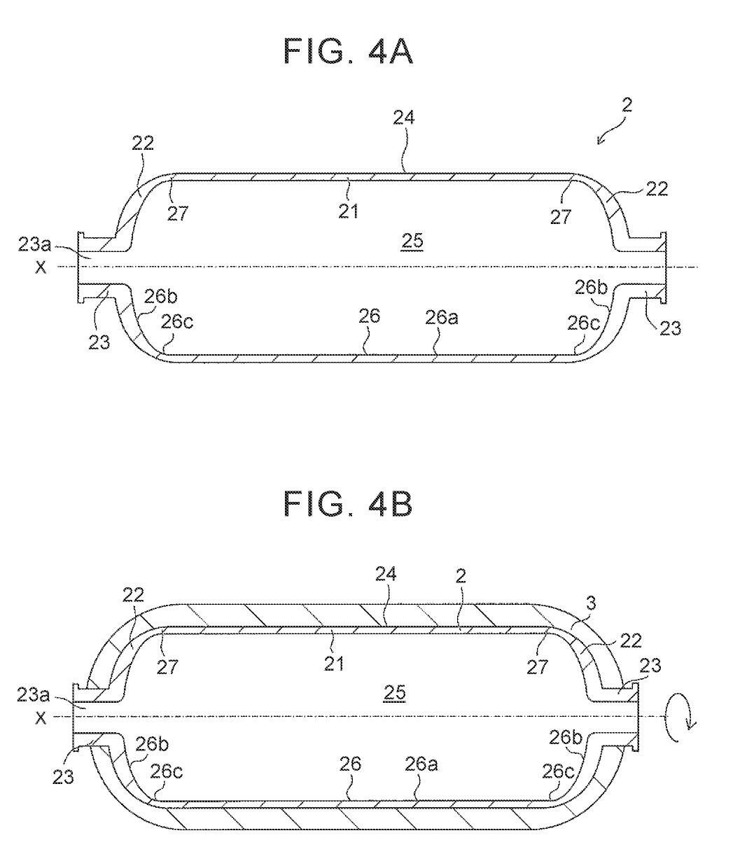

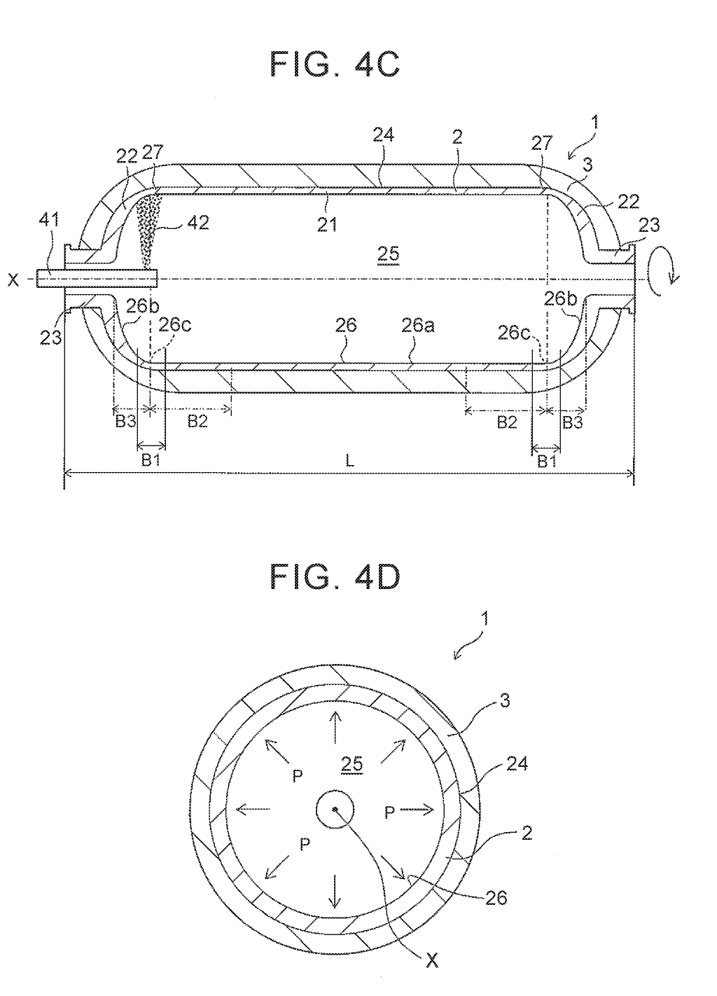

Next, with reference to FIG. 3, FIG. 4A, FIG. 4B, and FIG. 4C, a manufacturing method for the high pressure tank 1 is described. FIG. 3 is a flowchart describing steps of the manufacturing method for the high pressure tank 1 according to the embodiment. FIG. 4A is a schematic view describing a preparation step S11 shown in FIG. 3. FIG. 4B is a schematic view describing a reinforcing layer forming step S12 shown in FIG. 3. FIG. 4C is a schematic view describing a shot peening step S13 shown in FIG. 3. FIG. 4D is a schematic view describing an autofrettage pressure application step S16 included in an autofrettage step S15 shown in FIG. 3. FIG. 4A to FIG. 4C are sectional views taken along the axis X of the high pressure tank 1 (precisely, the liner 2), and FIG. 4D is a sectional view orthogonal to the axis X.

Preparation Step S11

In the manufacturing method according to the embodiment, first of all, the preparation step S11 is carried out where the liner 2 is prepared. As shown in FIG. 4A, in the step, the metal liner 2 is prepared. The liner 2 includes the cylindrical body portion 21, and the dome-shaped side end portions 22 that are formed continuously with both sides of the body portion 21, respectively.

In the embodiment, the liner 2 is manufactured by spinning. To be more specific, first of all, a metal cylindrical body is prepared which has a thickness and an outer diameter equivalent to those of the body portion 21 of the liner 2. Next, while the cylindrical body is rotating around the axis X of the cylindrical body, a forming roller is pressed against each end portion of the cylindrical body and the end portions of the cylindrical body are plastically deformed. Thus, the side end portions 22 are formed. As a result, the liner 2 is obtained which has the cylindrical body portion 21 and the dome-shaped side end portions 22 that are formed so as to be continuous with both sides of the body portion 21, respectively. Further, the mouthpiece 23 having the opening 23a is formed in each of the side end portions 22. Furthermore, due to the spinning, the thickness of the liner 2 increases towards each of the side end portions 22 from the boundary 27 between the body portion 21 and each of the side end portions 22.

In the embodiment, the liner 2 is manufactured by the spinning. However, for example, a cylindrical body corresponding to the body portion 21 and dome-shaped members corresponding to the side end portions 22 may be joined together by heat seal, welding or the like in order to manufacture the liner 2.

Reinforcing Layer Forming Step S12

Next, the reinforcing layer forming step S12 is carried out. As shown in FIG. 4B, in this step, the reinforcing layer 3 is formed by winding fiber-reinforced resin around the outer peripheral surface 24 of the liner 2. To be specific, while the liner 2 is rotating around the axis X, filament (fiber bundle) of reinforcing fiber impregnated with polymeric resin is wound around the outer peripheral surface 24 of the liner 2 as a layer in hoop and helical winding patterns by using a filament winding method (an FW method).

In the embodiment, the filament winding method (the FW method) is used to form the reinforcing layer 3. However, a sheet of reinforcing fiber impregnated with polymeric resin may be wound around the outer peripheral surface 24 of the liner 2 by using a sheet winding method.

When the polymeric resin impregnated in the reinforcing fiber is thermoplastic resin, filament made from reinforcing fiber is wound around the outer peripheral surface 24 of the liner 2 in a state where the thermoplastic resin is softened by heating the filament. Meanwhile, when the polymeric resin impregnated in the reinforcing fiber is thermosetting resin, filament impregnated with uncured thermosetting resin (that is fiber-reinforced resin) is wound around the outer peripheral surface 24 of the liner 2, and then the uncured thermosetting resin is thermally cured. Thus, the reinforcing layer 3 is formed.

Shot Peening Step S13

Next, the shot peening step S13 is carried out. As shown in FIG. 4C, in this step, shot peening is carried out by shooting shot materials 42 towards at least an inner periphery region 26c of the boundary 27 between the body portion 21 and each of the side end portions 22, out of the inner peripheral surface 26 of the liner 2. For the shot materials 42, particles made from metallic or ceramic material or the like that is harder than the material of the liner 2 are used. The particle may be, for example, an iron-based particle or an alumina particle with an outer diameter of 40 μm to 1500 μm.

In the embodiment, first of all, a shooting nozzle 41 is inserted into the housing space 25 from the opening 23a of the mouthpiece 23. Next, while the liner 2 on which the reinforcing layer 3 is formed is rotating around the axis X, the shot materials 42 injected from a shooting nozzle 41 is shot towards the inner periphery region 26c of each of the boundaries 27. Thus, the shot materials 42 collide with the inner periphery region 26c of the boundary 27 and its periphery, and shot peening is carried out in the collided parts. As a result, compressive residual stress is applied to a surface layer of the inner periphery region 26c and its periphery.

As shown in FIG. 4C, the inner periphery region 26c is an inner peripheral surface of the boundary 27 between the body portion 21 and each of the side end portions 22. Specifically, each of the inner periphery regions 26c is a linear (circumferential) portion where the inner diameter of the liner 2 starts to decrease from the body portion 21 of the liner 2 to the end portion of the liner 2 (specifically, the mouthpiece 23) along the axis X. The inner periphery region 26c is shown by a chain line in FIG. 4C.

Further, as shown in FIG. 4C, in the shot peening step S13, the shot materials 42 may be shot so that, when the inner periphery region 26c of the boundary 27 is considered as a center, a width B1 falls within a range of 5% to 30% of an entire length L of the liner 2 (specifically, a length of the liner 2 in a direction along the axis X). For example, when the width B1 is 5%, it is possible to reduce time for shot peening by about 63% compared to time for shot peening performed on the entire inner peripheral surface 26 of the liner 2.

Further, as shown in FIG. 4C, the shot materials 42 may be shot in a range from the inner periphery region 26c of the boundary 27 to an inner peripheral surface 26a of the body portion 21 of the tank so that a width B2 of the range becomes 25% or smaller of the entire length L of the liner 2. Also, the shot materials 42 may be shot in a range from the inner periphery region 26c to an inner peripheral surface 26b of the side end portion 22 so that the range has a width B3. In this case, the width B3 may be the entire width of the inner peripheral surface 26b of each of the side end portions 22.

Moreover, for example, in the sectional view in FIG. 4C, the width B3 may be a width between the inner periphery region 26c and a portion of the inner peripheral surface 26b where inclination is gentle. Specifically, in the sectional view in FIG. 4C, the portion of the inner peripheral surface 26b with gentle inclination is a portion where the inner peripheral surface 26b (specifically, a tangent of the inner peripheral surface 26b) is inclined at 45° or smaller with respect to the axis X. When the liner 2 is manufactured by spinning, the portion of the inner peripheral surface 26b with gentle inclination has a smaller thickness compared to that of the rest of the side end portion 22. Therefore, by also carrying out the shot peening on this portion, fatigue strength is enhanced as described later.

It is preferred that a magnitude of compressive residual stress applied by the shot peening on the surface layer of the liner 2 is 10 MPa to 400 MPa. When the magnitude is smaller than 10 MPa, it is not possible to sufficiently reduce tensile stress caused by internal pressure (autofrettage pressure) applied in the autofrettage step S15 described later. Meanwhile, when compressive residual stress of over 400 MPa is applied, the liner 2 itself can be deformed by the shot materials.

Such compressive residual stress is adjustable by setting pressure of compressed gas that injects the shot materials (shooting pressure), shooting time, and a material and a shape of the shot materials. In order to obtain such compressive residual stress, it is preferred that shooting pressure for the shot materials 42 is, for example, 0.4 MPa to 1.0 MPa, and shooting time is preferably one minute to 14 minutes per unit area.

Attaching Step S14

Next, an attaching step S14 is carried out. In this step, a valve (not shown) is attached to one of the mouthpieces 23, and a cap (not shown) is attached to the other mouthpiece 23. Thus, the housing space 25 of the liner 2 becomes a closed space. A gas supply portion (not shown) that supplies gas to the housing space 25 of the liner 2 is connected with the valve.

Autofrettage Step S15

Next, the autofrettage step S15 is carried out. In this step, first of all, in an autofrettage pressure application step S16, internal pressure (autofrettage pressure) is applied to the liner 2 so that the liner 2 is plastically deformed in a direction in which the liner 2 expands. Thereafter, in an autofrettage pressure elimination step S17, the internal pressure is eliminated. Thus, compression stress is applied to the liner 2. These steps are described below in detail.

In the autofrettage pressure application step S16, gas is filled inside the shot-peened liner 2 through the valve (not shown), and autofrettage pressure (internal pressure) P is applied to the metal liner 2 so that the liner 2 is plastically deformed (see FIG. 4D). To be specific, inert gas under a pressure of, for example, 70 MPa to 180 MPa is filled inside the housing space 25 from the gas supply portion through the valve, and internal pressure is thus applied to the liner 2 so that the liner 2 is plastically deformed.

Thus, tensile stress is applied to the plastically deformed liner 2, and the reinforcing layer 3 is deformed together with the plastic deformation of the liner 2. In this step, it is preferred that the liner 2 is deformed so that plastic strain of 0.2% to 15% is introduced to a metallic material used to form the liner 2. Deformation of the reinforcing layer 3 is close to elastic deformation.

Next, in the autofrettage pressure elimination step S17, the gas filled in the housing space 25 is released through the valve, and the autofrettage pressure (internal pressure) added in the autofrettage pressure application step S16 is eliminated. Once the gas is discharged and the internal pressure of the liner 2 is eliminated, the reinforcing layer 3 that is once deformed in the direction in which the high pressure tank 1 expands tries to contract back to an original shape due to its restoring force. However, because the liner 2 is plastically deformed, the liner 2 contracts into a shape that is slightly larger than its original shape. Since the reinforcing layer 3 applies the restoring force to the liner 2 so as to compress the liner 2, compression stress described later is applied to the entire liner 2. Due to the compression stress, fatigue strength of the liner 2 is improved when the high pressure tank 1 is used.

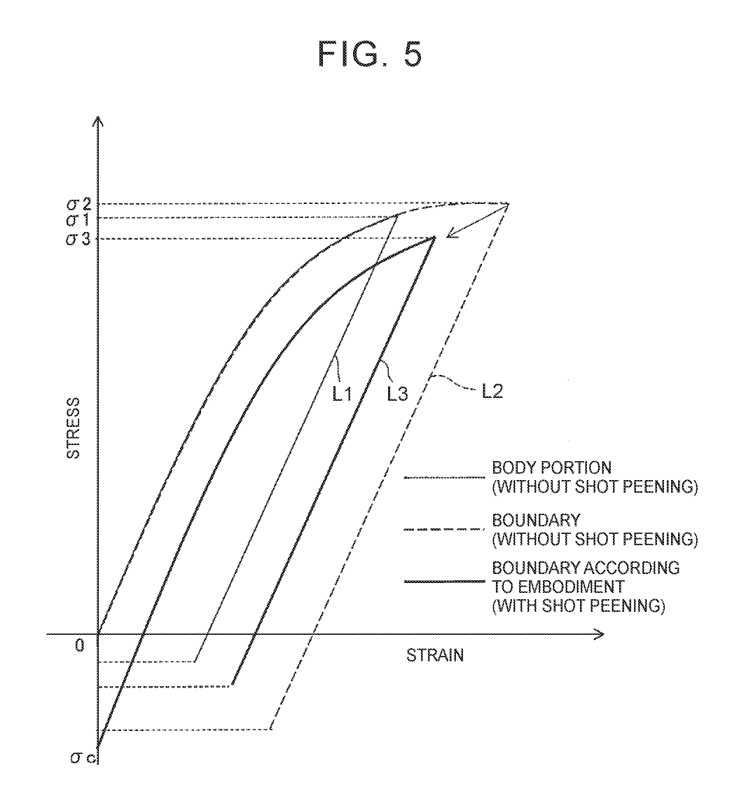

With reference to FIG. 5, effects of the foregoing compressive residual stress and compression stress are described. FIG. 5 shows a stress-strain curve regarding the body portion and each of the boundaries of the liner from the beginning of application of autofrettage pressure until elimination of the autofrettage pressure. FIG. 5 also shows a stress-strain curve regarding the body portion and each of the boundaries when the shot peening is not carried out. Curves L1, L2 show stress-strain curves of the body portion and each of the boundaries in the case where the shot peening is not carried out. A curve L3 is a stress-strain curve of the boundary 27 of the liner 2 according to the embodiment.

When the autofrettage pressure (internal pressure) is applied to the liner without performing the shot peening, stress tends to concentrate on the boundaries of the liner because the diameter of the liner is reduced gradually towards each of the end portions of the liner. Therefore, as understood from the curves L1, L2, when autofrettage pressure (internal pressure) is applied to the liner, tensile stress a2 acts on each of the boundaries, and the tensile stress a2 is larger than tensile stress a1 acting on the body portion of the liner. Therefore, as evident from a linear cumulative damage law (for example, Miner's law), fatigue strength (fatigue life) of each of the boundaries is decreased. In particular, when the liner is manufactured by spinning, a thickness of the liner increases from each of the boundaries between the body portion and each of the side end portions towards each of the side end portions as described above. Thus, stress tends to concentrate on each of the boundaries.

In the embodiment, since the shot peening step S13 is carried out before the autofrettage step S15, compressive residual stress ac is applied to the surface layer of the boundary 27 including the inner periphery region 26c as shown in the curve L3 in FIG. 5. Therefore, in the embodiment, tensile stress a3 in the boundary 27 caused by the autofrettage pressure is reduced so as to be smaller than tensile stress (the tensile stress a2 of the curve L2) when the compressive residual stress is not applied. Thus, it is possible to restrain degradation of fatigue strength of the liner 2.

As a result, when internal pressure is applied to the liner 2 during the autofrettage, a decrease in fatigue strength of each of the boundaries 27 in the liner 2 due to excessive tensile stress is restrained. Further, in the autofrettage step S15, after autofrettage pressure is eliminated, compression stress is applied to the entire liner 2 by restoring force of the reinforcing layer 3. Therefore, fatigue strength of the high pressure tank 1 while in use is improved as it is supposed to be.

In particular, when the liner 2 is manufactured by spinning in the preparation step S11, since the diameter of each of the side end portions 22 is reduced towards each of the end portions of the liner 2, the inner periphery region 26c of each of the boundaries 27 and the inner peripheral surface 26b of each of the side end portions 22 are wrinkled easily. Therefore, unlike the inner peripheral surface 26a of the body portion 21, the inner periphery region 26c of each of the boundaries 27 and the inner peripheral surface 26b of each of the side end portions 22 have surfaces with projections and recesses. Even in such a case, in the embodiment, when the shot peening is carried out on the inner periphery region 26c of each of the boundaries 27 and the inner peripheral surface 26b of each of the side end portions 22, their surfaces are smoothed. Therefore, due to the autofrettage, it is possible to restrain a decrease in strength of the boundaries 27 caused by the projections and recesses of the inner peripheral surfaces.

Further, when the reinforcing layer 3 is made from fiber-reinforced resin that is made from reinforcing fiber impregnated with thermosetting resin, in the reinforcing layer forming step S12, filament impregnated with uncured thermosetting resin is wound around the outer peripheral surface 24 of the liner 2, and then the thermosetting resin is thermally cured as described earlier. Thus, the reinforcing layer 3 is formed.

Since the reinforcing layer forming step S12 is carried out before the shot peening step S13, compressive residual stress applied by the shot peening on the surface layer that includes the inner periphery region 26c of each of the boundaries 27 is not released, and is thus not reduced nor eliminated. As a result, the compressive residual stress applied by the shot peening on the surface layer of each of the boundaries 27 is effectively utilized to carry out autofrettage. Therefore, while the high pressure tank 1 is in use, it is possible to restrain a decrease in fatigue strength of each of the boundaries 27 between the body portion 21 and each of the side end portions 22 of the liner 2.

In the embodiment, the reinforcing layer forming step S12 is carried out before the shot peening step S13. However, the shot peening step S13 may be carried out before the reinforcing layer forming step S12 as long as compressive residual stress applied by the shot peening is ensured.

### Another Embodiment

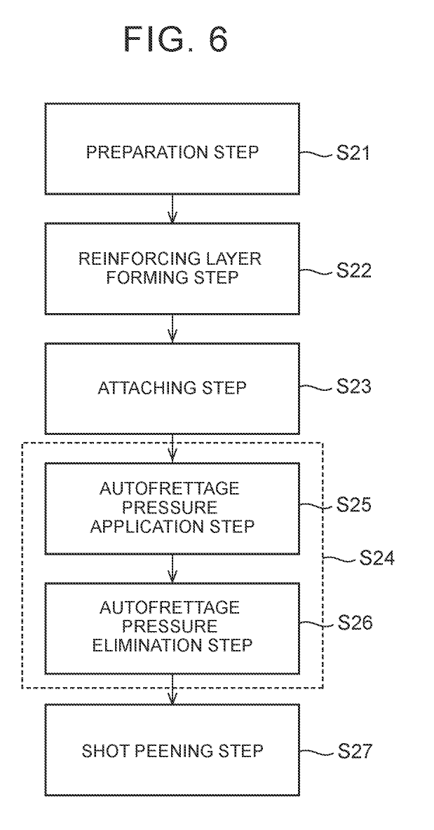

FIG. 6 is a flowchart describing steps of a manufacturing method for a high pressure tank 1 according to another embodiment. As shown in FIG. 6, the manufacturing method for the high pressure tank 1 according to another embodiment is different from the foregoing embodiment in that an autofrettage step S24 is carried out before a shot peening step S27. This difference is described below, the same reference numerals are used for the same members and parts as those of the foregoing embodiment, and detailed description is omitted. Another embodiment is described with reference to FIG. 1 and FIG. 6.

As shown in FIG. 6, in the manufacturing method according to another embodiment, first of all, a preparation step S21 and a reinforcing layer forming step S22 are carried out similarly to the foregoing embodiment. Next, an attaching step S23 is carried out. In these steps, same operations as those described in the embodiment are carried out. In another embodiment, the autofrettage step S24 is then carried out before the shot peening step S27.

In another embodiment, unlike the foregoing embodiment, the autofrettage step S24 is carried out first. The autofrettage step S24 includes an autofrettage pressure application step S25 and an autofrettage pressure elimination step S26, and what is carried out in these steps are the same as those in the foregoing the embodiment.

In another embodiment, shot peening is not carried out on each boundary 27 where autofrettage pressure is applied. Therefore, as described above, tensile stress on each of the boundaries 27 caused by autofrettage pressure is relatively larger than that of a body portion 21. After autofrettage pressure is eliminated, restoring force that compresses the liner 2 is generated in the reinforcing layer 3. Therefore, compression stress is generated in the body portion 21 and each of the boundaries 27.

Next, the shot peening step S27 is carried out. Similarly to the foregoing embodiment, in the shot peening step S27, the shot peening is carried out by shooting shot materials 42 towards an inner periphery region 26c of each of the boundaries 27 between the body portion 21 and each of the side end portions 22. Thus, compressive residual stress is applied even further to a surface layer of the inner periphery region 26c of each of the boundaries 27 after the autofrettage step S24.

As a result, when the high pressure tank 1 is used, even when gas is filled in and released from the high pressure tank 1 repeatedly, it is possible to improve fatigue strength of the liner 2 because higher compression stress considering compressive residual stress is applied to each of the boundaries 27 than the rest of the parts.

Also in another embodiment, when the liner 2 is manufactured by spinning, by carrying out the shot peening on the inner periphery region 26c of each of the boundaries 27 and the inner peripheral surface 26b of each of the side end portions 22, their surfaces are smoothed. Thus, even when gas is filled in and released from the high pressure tank 1 repeatedly while the tank 1 is in use, stress is less concentrated on these surfaces, and fatigue strength of the liner 2 is improved.

The embodiments of the disclosure have been described in detail. However, the disclosure is not limited to these embodiments, and various design changes may be made without departing from the spirit of the disclosure described in claims.

What is claimed is:

1. A manufacturing method for a high pressure tank, comprising:
preparing a liner that stores gas and includes a body portion having a cylindrical shape and a pair of side end portions having dome shapes, the liner being made of a metal, the side end portions being formed continuously with both sides of the body portion, respectively;
forming a reinforcing layer by winding fiber-reinforced resin around an outer peripheral surface of the liner;
carrying out shot peening by shooting a shot material towards an inner periphery region of a boundary between the body portion and each of the side end portions out of an inner peripheral surface of the liner; and
carrying out autofrettage after the reinforcing layer is formed and the shot peening is carried out, the autofrettage being carried out by applying internal pressure to the liner such that the liner is plastically deformed and then eliminating the internal pressure such that compression stress is applied to the liner.

2. The manufacturing method according to claim 1, wherein the shot material is shot towards a range from the inner periphery region of the boundary through an inner peripheral surface of each of the side end portions when the shot peening is carried out.

3. The manufacturing method according to claim 1, wherein:
the fiber-reinforced resin is made from reinforcing fiber impregnated with thermosetting resin;
the reinforcing layer is formed by winding the fiber-reinforced resin made from the reinforcing fiber impregnated with the thermosetting resin that is uncured around the outer peripheral surface of the liner, and then thermally curing the thermosetting resin; and
the reinforcing layer is formed before the shot peening is carried out.

4. The manufacturing method according to claim 1, wherein, during the autofrettage, inert gas under pressure of 70 MPa to 180 MPa is filled inside the liner such that internal pressure is applied to the liner.

5. The manufacturing method according to claim 1, wherein the shot peening applies compressive residual stress of 10 MPa to 400 MPa to a surface layer of the liner.

6. A manufacturing method for a high pressure tank, comprising:
preparing a liner that stores gas and includes a body portion having a cylindrical shape and a pair of side end portions having dome shapes, the liner being made of a metal, the side end portions being formed continuously with both sides of the body portion, respectively;
forming a reinforcing layer by winding fiber-reinforced resin around an outer peripheral surface of the liner;
carrying out autofrettage by applying internal pressure to the liner such that the liner is plastically deformed and then eliminating the internal pressure such that compression stress is applied to the liner,
carrying out shot peening by shooting a shot material towards an inner periphery region of a boundary between the body portion and each of the side end portions out of an inner peripheral surface of the liner after the reinforcing layer is formed and the autofrettage is carried out.

7. The manufacturing method according to claim 6, wherein the shot material is shot towards a range from the inner periphery region of the boundary through an inner peripheral surface of each of the side end portions when the shot peening is carried out.

8. The manufacturing method according to claim 6, wherein:
the fiber-reinforced resin is made from reinforcing fiber impregnated with thermosetting resin; and
the reinforcing layer is formed by winding the fiber-reinforced resin made from the reinforcing fiber impregnated with the thermosetting resin that is uncured around the outer peripheral surface of the liner, and then thermally curing the thermosetting resin.

9. The manufacturing method according to claim 6, wherein, during the autofrettage, inert gas under pressure of 70 MPa to 180 MPa is filled inside the liner such that internal pressure is applied to the liner.

10. The manufacturing method according to claim 6, wherein the shot peening applies compressive residual stress of 10 MPa to 400 MPa to a surface layer of the liner.
